(19) United States
(12) Patent Application Publication
(10) Pub. No.: US 2026/0134785 A1
(43) Pub. Date: May 14, 2026

(54) SYSTEM AND METHOD FOR ENHANCING LEARNING EFFICIENCY USING MULTIMODAL PRIMING STIMULI

(71) Applicant: Yiannis Laouris, Washington DC, DC (US)

(72) Inventor: Yiannis Laouris, Washington DC, DC (US)

(21) Appl. No.: 18/947,025

(22) Filed: Nov. 14, 2024

(51) Int. Cl. G09B 5/06

(52) U.S. Cl. CPC G09B 5/06

(57) ABSTRACT

Disclosed is a method for enhancing learning efficiency in digital or physical learning environments. The method being implemented using a Learning Object Sequencer (LO-SEQ) system. The method includes scheduling a learning object (LO) to be presented to a learner in at least one of a plurality of modalities. A very short priming object (vs-PO) is presented as a priming stimulus, wherein the vs-PO is semantically or conceptually related to the scheduled LO to be subsequently presented. The scheduled LO is subsequently presented after a predefined time period of presenting the vs-PO.

### FIELD OF THE INVENTION

The present invention relates to learning techniques in educational environments,

and more particularly, relates to system and method for enhancing learning efficiency using multimodal priming stimuli.

### BACKGROUND OF THE INVENTION

In modern education, Learning Objects (LOs) have become a cornerstone of both digital and physical learning environments. LOs are defined as modular educational resources designed to achieve a specific learning objective. Types of LOs include but not limited to including text, images, audio, video, simulations, and interactive quizzes. These are designed to support a focused piece of knowledge or skill. A key characteristic of LOs is their modularity, which allows for flexibility in their reuse across different learning contexts, courses, or lessons. This modularity enables LOs to be customized for individual learners or specific learning objectives, making them an integral part of adaptive learning systems.

The concept of Learning Objects also emphasizes reusability and interoperability—qualities that make them well-suited for integration into diverse educational frameworks. By repurposing LOs, educational content can be efficiently adapted to various platforms and learning environments, such as e-learning systems, corporate training environments, or traditional classroom settings. As education becomes increasingly digitized, the need for scalable, adaptable, and efficient learning resources has made LOs a critical component in delivering personalized and flexible learning experiences.

A key challenge in effectively utilizing LOs is determining the optimal sequence in which they are presented to the learner. This is where Learning Object Sequencers (LO-SEQs) play a pivotal role. Traditional LO-SEQ systems determine the order of LOs based on predefined criteria, such as the complexity of the content, the learner's progress, or the overall course objectives. These sequencers generally follow a linear or hierarchical progression, guiding the learner from simpler concepts to more complex material, and ensuring prerequisite knowledge is established before introducing advanced topics. However, this approach may not fully optimize the learner's cognitive engagement, as it overlooks dynamic psychological factors that influence the learning process. One such psychological factor is the priming effect, a well-established concept in cognitive psychology. Despite the proven benefits of priming in learning, traditional LO-SEQ systems do not incorporate priming as part of the sequencing process, leading to a gap in maximizing the learner's cognitive potential.

The reference Japan Patent Publication No. 2022536356, titled “Non-invasive System and Method for Detecting and Modulating a User's Mental State through Subjective Priming Effect,” discloses a system that utilizes non-invasive techniques to detect and modulate a user's mental state through neuro-feedback, specifically focusing on priming effects to alter mental states such as relaxation and focus. Although the reference employs the concept of priming, it failed to disclose the integration of priming stimuli within Learning Object Sequencers (LOS) to enhance learning efficiency.

The reference Canadian U.S. Pat. No. 2,414,209 titled “Compiling and distributing modular electronic publishing and electronic instruction materials” discloses a method for distributing modular instructional materials, dynamically adapting the sequence of LOs based on learner progress. Although the reference discloses dynamic sequencing of learning content, it failed to disclose incorporating Very Short Priming Objects (vs-PO) to prime the learner's cognitive system for optimizing learning outcomes through the neuro-psychological priming effect.

The reference Australian Patent 2017201279 titled “Methods and systems for dynamically generating a training program” focuses on the creation of personalized training programs through dynamic generation based on user performance and preferences. However, the reference failed to teach using priming stimuli to prepare learners for the subsequent learning objects for enhancing their cognitive readiness rather than merely responding to performance metrics.

The reference Chinese U.S. Pat. No. 102,737,120 titled “Personalized Network Learning Resource Recommendation Method” discloses a method for personalized recommendation of learning resources by analyzing behavioral data and learning interest paths. However, the reference failed to disclose the use of priming to prepare the learner for upcoming content for improving learning efficiency, as opposed to relying solely on behavioral data analysis for resource recommendations.

The reference Chinese U.S. Pat. No. 105,512,349 titled “Adaptive Learning Answering Method and Device” discloses a system that adapts learning content based on a learner's responses during assessments. While the reference focuses on adaptive learning, it failed to disclose integration of priming stimuli for enhancing cognitive processing before learners encounter the main content.

The reference Korean U.S. Pat. No. 101,431,050 titled “System for Adaptive Teaching and Learning” discloses a system for adaptive teaching that predicts future learning needs based on learner progress. However, it failed to teach of method of cognitive enhancement through priming stimuli for improving learning readiness before the presentation of learning objects, rather than solely relying on predictive models of learner progress.

The reference U.S. Pat. No. 7,052,277 titled “Adaptive Learning System for Sequencing Learning” discloses a system that sequences learning objects based on the learner's knowledge level and interaction with the material. While the reference discusses sequence learning content it failed to address the use of priming stimuli (vs-PO) to enhance the learner's cognitive efficiency.

The reference U.S. Pat. No. 10,360,809 titled “Course Skeleton for Adaptive Learning” discloses a framework for adaptive learning in which course modules are dynamically adjusted based on competencies and progress. However, the reference did not disclose the use of priming stimuli to cognitively prime learners before the presentation of learning materials.

The reference United States Publication No. 20200374362 titled “Dynamic Hybrid Content Sequencing” focuses on dynamically sequencing hybrid content based on learner engagement and progress. However, it failed to teach neuro-psychological priming to improve learning efficiency.

Hence, there is a need for a system, method or algorithm that enhances one's learning efficiency while considering psychological factors influencing the learning process. In other words, there is a need for a system, method or algorithm that addresses the limitations of traditional LO sequencing by integrating the Priming Effect into the sequencing process.

### BRIEF SUMMARY OF THE INVENTION

It is an objective of the present invention to enhance learning efficiency by incorporating the cognitive priming effect into the sequencing of Learning Objects (LOs).

It is another objective of the present invention to integrate a Very Short Priming Object (vs-PO) as a stimulus to prepare learners for subsequent learning content.

It is further objective of the present invention to facilitate multimodal learning by allowing priming stimuli and LOs to be presented through various sensory modalities.

It is yet another objective of the present invention to improve LO-Sequencing (LO-SEQ) by dynamically optimizing the order of content based on cognitive readiness and priming effects.

It is further objective of the present invention to increase the flexibility and reusability of LOs and priming stimuli for adaptation across different educational contexts.

It is another objective of the present invention to enhance cognitive processing and retention by presenting priming stimuli that are semantically or conceptually related to the LO.

According to an embodiment of the present invention, a method for enhancing learning efficiency in digital or physical learning environments is disclosed. The method being implemented using a Learning Object Sequencer (LO-SEQ) system. The method includes scheduling a learning object (LO) to be presented to a learner in at least one of a plurality of modalities. A very short priming object (vs-PO) is presented as a priming stimulus, wherein the vs-PO is semantically or conceptually related to the scheduled LO to be subsequently presented. The scheduled LO is subsequently presented after a predefined time period of presenting the vs-PO.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a schematic view of delivering very short Priming Object (vs-PO) before presenting a learning object (LO)

FIG. 2 is a schematic view of different modalities of vs-PO and LO.

FIG. 3 is a block flow diagram of a Learning Object Sequencer (LO-SEQ) system.

FIG. 4 is a flowchart illustrating a method for enhancing learning efficiency in digital or physical learning environments.

FIG. 5 is a block diagram of a computer system for implementing the LO-SEQ system of FIG. 3.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention disclosed herein is a method for enhancing learning efficiency in both digital and physical learning environments. In specific aspects, the neuro-psychological priming effects are delivered via a Learning Object Sequencer (LO-SEQ) system, to improve the cognitive processing of learning materials. The priming effect is accomplished by presenting a Very Short Priming Object (vs-PO), which is semantically or conceptually related to a subsequent Learning Object (LO). The vs-PO serves as a cognitive stimulus that primes the learner for more effective learning and comprehension.

The vs-PO is presented in a plurality of modalities, including but not limited to words, phrases, sounds, images, videos or combinations thereof. It is delivered before the LO is being presented, which allows the learner to prepare cognitively for the subsequent task. The present invention is adaptable to various learning environments, including both digital platforms and physical teaching environments. Further, the invention allows for the delivery of the vs-PO and LO in a variety of modalities, such as visual, auditory, or kinesthetic formats.

Typically, priming occurs when exposure to one stimulus influences the response to a subsequent stimulus, typically enhancing cognitive processing and recall. By presenting a related but simpler stimulus before the primary learning content, priming can facilitate deeper understanding and retention of the material.

According to an embodiment of the present invention, a Learning Object Sequencer (LO-SEQ) system 100 is disclosed. The LO-SEQ system 100 is configured to enhance learning efficiency by optimizing the presentation of learning materials using neuro-psychological priming. The system 100 comprises a processor and memory configured to execute algorithms that determine the order of learning materials and deliver them to the learner in a cognitively efficient manner.

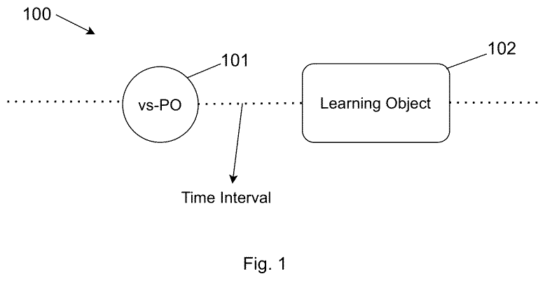

In an exemplary embodiment, the LO-SEQ system 100 performs the selection and presentation of a vs-PO 101. The vs-PO 101 is carefully chosen to be semantically or conceptually related to a subsequent LO 102. As known in the art, the priming reduces cognitive load, improves focus, and enhances the efficiency of knowledge acquisition. Referring FIG. 1, the LO-SEQ system 100 optimizes these effects by ensuring that the vs-PO 101 is delivered a variable time before the LO 102, depending on the learner's readiness and the complexity of the material.

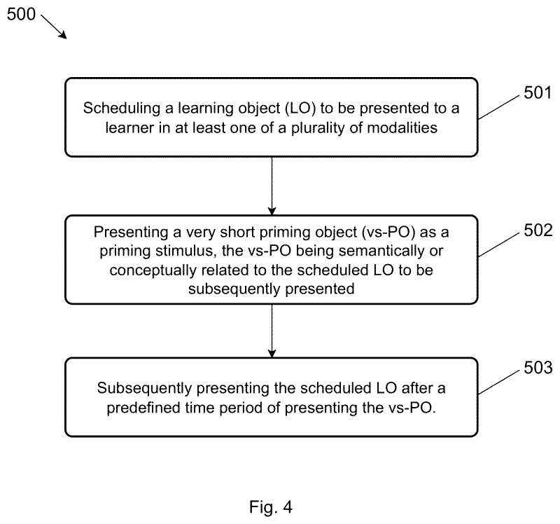

According to another exemplary embodiment, a method 500 for enhancing learning efficiency in digital or physical learning environments is disclosed as shown in FIG. 4. The method 500 is being implemented using a Learning Object Sequencer (LO-SEQ) system 400, which will be detailed in later sections. The method 500 involves scheduling 501 a learning object (LO) to be presented to a learner in at least one of a plurality of modalities. A very short Priming Object (vs-PO) is presented 502 as a priming stimulus. The vs-PO is selected from a plurality of vs-POs by correlating with the scheduled LO based on a number of techniques including but not limited to metadata matching, semantic similarity analysis, concept mapping and ontologies, modality matching, and cognitive load and engagement metrics. In an exemplary embodiment, the LO is subsequently presented 503 corresponding to the priming stimulus after a predefined time period of presenting the vs-PO. The vs-PO and LO are delivered in a plurality of modalities. In some embodiments, the vs-PO is semantically or conceptually related to the scheduled LO to be subsequently presented. However, in some embodiments, the vs-PO is presented regardless of the learning style or the format of the LO. For example, the vs-PO may be presented in a visual format (e.g., an image or video), while the LO may be presented in an auditory format (e.g., a spoken lecture or audio file). This flexibility ensures that the learner's cognitive engagement is maximized, regardless of their learning style or the format of the learning material.

In an exemplary aspect, the vs-PO and LO are allowed 503 to be delivered in a plurality of modalities, wherein the plurality of modalities includes visual, auditory, and kinesthetic stimuli. In one aspect, the LO is presented in the form of interactive content, text, video, or audio that builds upon the concepts introduced by the vs-PO.

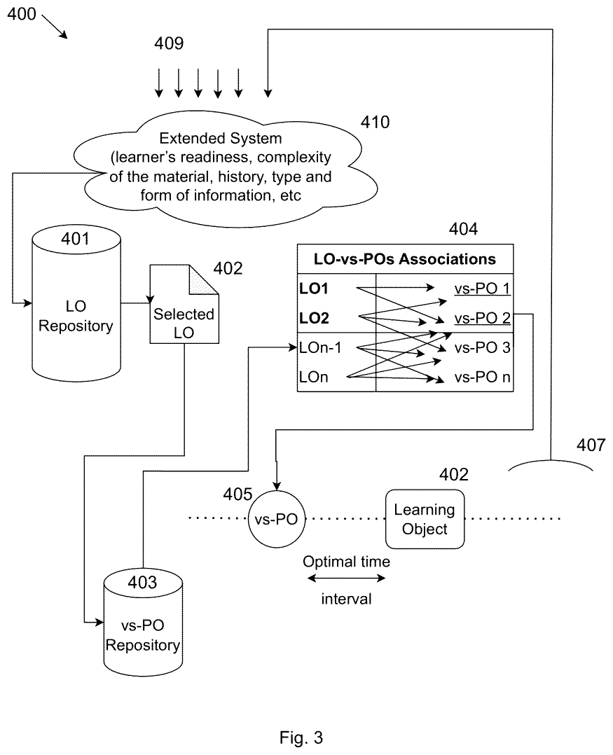

In an embodiment, referring FIG. 3, an LO-SEQ system 400 includes a database 401 or table, i.e. LO repository 401, from which an LO 402 is scheduled or selected to be presented to the user. Based on the scheduled LO 402, a plurality of vs-POs are correlated 404 with the selected LO 402 for selecting an appropriate vs-POs 405, wherein the plurality of vs-POs are stored in a vs-PO repository 403. The vs-PO 405 primes the learner for the exact type of information they will encounter in the LO 402.

The vs-POs are correlated with the selected LO 402 based on a number of techniques including but not limited to metadata matching, semantic similarity analysis, concept mapping and ontologies, modality matching, and cognitive load and engagement metrics. In an exemplary aspect, using metadata matching technique, each vs-PO and LO 402 are tagged with metadata describing their subject matter, topic, or core concept (e.g., physics, literature, math). The LO-SEQ system 400 use these tags to match vs-POs that relate closely to the LO's subject matter. Metadata also includes learning goals associated with each LO 402. For example, if an LO's goal is to teach vocabulary in a new language, the vs-PO 405 is selected based on its relevance to basic vocabulary concepts. In one aspect, both vs-POs 405 and LOs 402 are tagged with difficulty levels (e.g., beginner, intermediate, advanced). The system 400 can prioritize vs-POs 405 that match the LO's 402 difficulty level to ensure the priming is suitable for the learner's level.

In another exemplary aspect, using semantic similarity analysis, the system 400 analyzes the content of vs-POs and LOs 402, using natural language processing (NLP), to assess semantic similarity. For instance, a priming object containing the term “photosynthesis” correlates with an LO 402 that covers plant biology. In one aspect of semantic similarity analysis, the system 400 generates vector representations of both vs-PO and LO 402 content using embedding models like Word2Vec, GloVe, or BERT. Correlation can then be assessed based on the similarity of these vectors, identifying the most semantically aligned vs-PO 405 for each LO 402.

In another exemplary aspect, using concept mapping and ontologies technique, if vs-POs and LO 402 are mapped onto a knowledge graph or ontology, the system 400 can select a vs-PO 405 by identifying closely related concepts within the hierarchy. For example, in an educational ontology, if the LO 402 is on “chemical reactions,” a vs-PO on “atoms and molecules” may be identified as relevant based on its placement within the hierarchy. In another aspect, the system 400 maps LO 402 to specific knowledge prerequisites and use vs-POs that touch on foundational or preparatory knowledge, ensuring priming is relevant to the learner's current stage.

In yet another exemplary embodiment, using cognitive load and engagement metrics technique, the system 400 can adjust vs-PO selection based on a learner's past performance or familiarity with the subject. For example, if a learner is familiar with introductory physics, the vs-POs selected for physics LOs 402 could introduce slightly advanced concepts to build on existing knowledge. In one aspect, the system 400 could use real-time engagement metrics (e.g., time spent on past LOs, quiz performance) to dynamically adjust vs-POs. If a learner shows low engagement in recent sessions, the system 400 could choose a more stimulating vs-PO 405, such as one with multimedia elements or interactive content.

In yet another exemplary embodiment, the system 400 matches learning styles: If the LO 402 is presented in a specific modality (e.g., visual for a slide presentation), the system 400 can select a vs-PO 405 that matches this modality. A vs-PO 405 that visually introduces a key concept would help prepare learners for visual learning material in the LO 402.

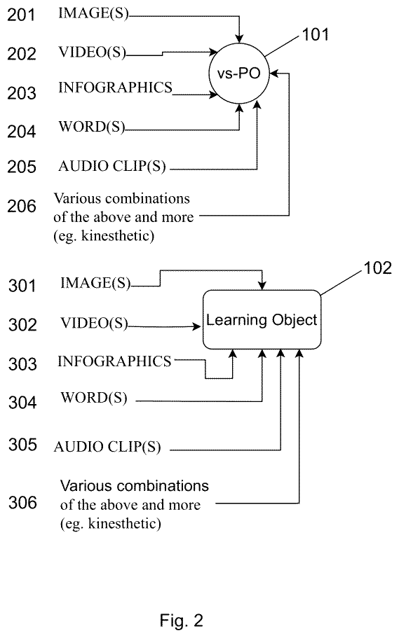

Once selected using one of the aforesaid techniques, the vs-PO 405 is presented as a priming stimulus after a predefined time period of presenting the vs-PO. In an exemplary aspect, referring FIG. 2, the system 100 allows the vs-PO 101 and LO 102 to be delivered in a plurality of modalities. The modalities of vs-PO 101 correspond to the LO 102 to be delivered. Referring FIG. 2, the modalities of vs-PO 101 include but not limited to: 1) visual such as images 201, video clips 202 and infographics 203, 2) auditory such as spoken words 204 and short audio clips 205, and 3) kinesthetic 206 such as interactive elements and haptic feedback. The modalities of LO 102 include but not limited to: 1) visual such as images 301, video clips 302 and infographics 303, 2) auditory such as spoken words 304 and short audio clips 305, and 3) kinesthetic 306 such as interactive elements and haptic feedback. In some embodiments, the vs-PO 101 is semantically or conceptually related to the scheduled LO 102 to be subsequently presented. However, in some embodiments, the vs-PO 101 is presented regardless of the learning style or the format of the LO 102. For example, the vs-PO 101 may be presented in a visual format (e.g., an image 201 or video 202), while the LO 102 may be presented in an auditory format (e.g., a spoken lecture 304 or audio file 305). This flexibility ensures that the learner's cognitive engagement is maximized, regardless of their learning style or the format of the learning material.

In one embodiment, referring FIG. 3, the LO-SEQ system 400 includes a feedback module 410 that collects data, as feedback 407, 409, from the learner after they engage with the LO 402. This feedback 407, 409 can include but not limited to performance data, such as quiz results, comprehension scores, or engagement metrics (e.g., time spent on the task). In one embodiment, the feedback includes previously selected and presented LO 407. The feedback 407, 409 is then used to adjust future vs-PO and LO pairings for creating a dynamically adaptive learning experience. This ensures that the system 400 continues to optimize learning efficiency over time by adapting the sequence of materials to the learner's needs.

In specific, the LO-SEQ system 400 is used in a wide variety of learning environments, including: 1) digital learning platforms such as online courses, educational apps, and interactive tutoring systems, 2) physical learning environments such as traditional classrooms, workshops, and labs, 3) hybrid environments such as blended learning systems that combine physical and digital elements, and in contexts where learners are required to process complex or abstract information, as the priming effect helps reduce cognitive load and improve comprehension.

The following examples demonstrate various methods of embodiment.

### Example 1: Priming Visual LOs 102 for Vocabulary Acquisition

In an online language learning system, a user is presented with a sequence of Los that progressively teach new vocabulary words. To enhance the learner's retention and speed of acquisition, the system first presents a vs-PO 101—a simple image related to the upcoming vocabulary word (e.g. an image of an apple).

The vs-PO 101 i.e. the image of the apple serves as a priming stimulus, preparing the learner to more efficiently process the next LO 102, which introduces the word “apple” and its pronunciation in the target language. After viewing the vs-PO 101, the learner is then presented with the corresponding LO 102, which includes the written word, pronunciation, and a brief example sentence.

The priming effect from the image enhances the learner's cognitive readiness, resulting in faster recognition and better retention of the vocabulary.

### Example 2: Auditory Priming in a History Course

In a digital history course, learners are presented with content about major historical events. The system 100 uses an auditory vs-PO 101 to prime learners before they receive detailed content about a specific event.

Method of Implementing auditory priming:
The system 100 first plays a vs-PO 101, which is a short sound clip of a significant moment related to the upcoming historical event, e.g. the sound of a ticking clock before the content about the invention of the mechanical clock in medieval Europe. The learner then receives the main LO 102, which includes a detailed description of the event, its context, and its impact on society.

By priming the learner with the auditory vs-PO 101, the system 100 enhances the learner's engagement and comprehension, as the priming effect helps the learner mentally prepare for the information.

### Example 3: Cross-Modal Priming in a Science Lesson

In a science e-learning platform, the system 100 delivers content on photosynthesis to students. The system 100 uses cross-modal priming, where the vs-PO 101 is delivered in a different modality than the main LO 102.

### Method of Implementing Cross-Modal Priming:

The system 100 plays a vs-PO 101 in the form of a brief auditory description, e.g. The process by which plants turn sunlight into energy, before playing the main visual LO 102, which includes a detailed infographic of the photosynthesis process.
The auditory vs-PO 101 serves as a primer to enhance the cognitive readiness of the learner, who is then able to process the complex visual infographic more efficiently.

This cross-modal priming approach leverages the psychological benefits of engaging multiple senses, boosting retention and understanding.

### Example 4: Priming with Kinesthetic Learning for Physical Skills Training

In a sports training app, the system 100 teaches users a specific tennis swing technique. The system 100 uses a kinesthetic vs-PO 101 to prime the learner's muscle memory before the detailed instructional video is presented.

Method of Implementing Priming with Kinesthetic Learning:
The system first presents a vs-PO 101 in the form of a brief, animated visual that shows the learner the key arm movement required for the swing, e.g., a short, looping animation of the correct racket motion. Immediately following the vs-PO 101, the learner is presented with a more comprehensive LO 102, which includes a step-by-step video tutorial on how to execute the swing, including body positioning and footwork.

The initial visual priming prepares the learner to better absorb and execute the movements in the main instructional content, resulting in improved physical learning outcomes.

### Example 5: Priming in Mathematics Problem Solving

A digital math tutoring platform uses priming to help students learn how to solve algebraic equations. Before presenting a complex equation, the system provides a vs-PO 101 designed to trigger the student's recognition of relevant mathematical operations.

### Method of Implementing Priming in Mathematics Problem Solving:

The vs-PO 101 is a short visual cue, such as an animation of a simple equation, e.g. “2×+3=7”, with its solution displayed as e.g. “x=2”.
This primes the learner for the more complex algebraic equation that follows in the main LO 102 for e.g. “5×−7=3”.
The vs-PO 101 primes the learner by activating prior knowledge of basic algebraic principles, enabling the learner to approach the more difficult problem with greater confidence and cognitive readiness.

### Example 6: Priming in Music Education

In an online music education platform, learners are taught to play specific chords on a piano. The system uses auditory and visual vs-PO 101 to prime the learner's understanding of the chord structure before providing full instructions.

### Method of Implementing Priming in Music Education:

The system allows a vs-PO 101 play a brief audio clip of the chord, e.g. a C major chord, before showing the learner the full musical notation and finger placement for the chord. The auditory priming helps the learner recognize the sound of the chord, while the subsequent visual representation in the LO 102 provides detailed instructions on how to play it.
The combination of auditory priming and visual instruction enhances the learner's ability to understand and play the chord.

Therefore, it is understandable that the present invention provides an innovative method and system for enhancing learning efficiency using the neuro-psychological Priming Effect. By sequencing learning materials with semantically or conceptually related priming objects, the LO-SEQ system 100 optimizes the cognitive processing of learners, leading to improved retention, comprehension, and overall learning outcomes. The flexibility of the system in terms of modality selection, dynamic content delivery, and adaptive feedback makes it applicable to a broad range of learning environments, thereby ensuring that learners can engage with content in a manner that is both efficient and personalized.

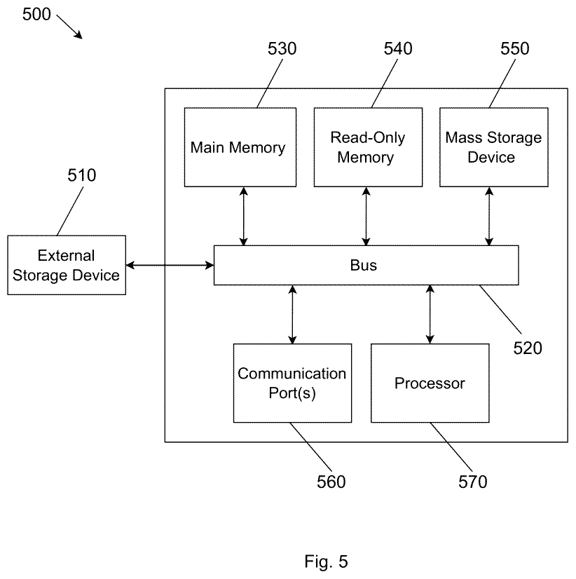

FIG. 5 illustrates an exemplary computer system 500 in which the embodiments of the present invention may be utilized. Based on the implementation, the various process and decision blocks described above in the system 400 may be performed using one or more hardware components, embodied in machine-executable instructions, which may be used to cause a general-purpose or special-purpose processor programmed with the instructions to perform the steps, or the steps may be performed by a combination of hardware, software and/or firmware. As shown in FIG. 5, the computer system 500 includes an external storage device 510, a bus 520, a main memory 530, a read-only memory 540, a mass storage device 550, one or more communication ports 560, and a processor 570.

In some embodiments, the computer system 500 may include one or more processors 570 and one or more communication ports 560. The one or more processors 570 should be understood to mean circuitry based on one or more microprocessors, microcontrollers, digital signal processors, programmable logic devices, Field-Programmable Gate Arrays (FPGAs), Application-Specific Integrated Circuits (ASICs), and Graphic Processing Unit (GPU) etc., and may include a multi-core processor (e.g., dual-core, quad-core, Hexa-core, or any suitable number of cores) or supercomputer. In some embodiments, the one or more processors 570 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the one or more processors 570 include, but are not limited to, an Intel® Itanium® or Itanium 2 processor(s), AMD® Opteron® or Athlon MPO processor(s), Motorola® lines of processors, System on Chip (SoC) processors, or other future processors. The one or more processors 570 may include various modules associated with embodiments of the present disclosure.

The communication ports 560 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communication ports 560 may include circuitry that enables peer-to-peer communication of electronic devices or communication of electronic devices in locations remote from each other. The communication ports 560 may be any RS-232 port for use with a modem-based dialup connection, a 10/100 Ethernet port, a Gigabit, or a 10 Gigabit port using copper or fiber, a serial port, a parallel port, or other existing or future ports. The communication ports 560 may be chosen depending on a network, such as a Local Area Network (LAN), Wide Area Network (WAN), or any network to which the computer system 500 may be connected.

The main memory 530 may include Random Access Memory (RAM) or any other dynamic storage device commonly known in the art. Read-only memory (ROM) 540 may be any static storage device(s), e.g., but not limited to, a Programmable Read-Only Memory (PROM) chips for storing static information, e.g., start-up or BIOS instructions for the one or more processors 570.

The mass storage device 550 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 530. The mass storage device 550 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 520 communicatively couples the processors 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processors 570 to the software system.

Optionally, operator and administrative interfaces, e.g., a display, keyboard, and a cursor control device, may also be coupled to the bus 520 to support direct operator interaction with the computer system 500. Other operator and administrative interfaces may be provided through network connections connected through the communication ports 560. The external storage device 510 may be any kind of external hard drives, floppy drives, IOMEGA® Zip Drive, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the exemplary computer system limit the scope of the present disclosure.

The computer system 500 may be accessed through a user interface. The user interface application may be implemented using any suitable architecture. For example, it may be a stand-alone application wholly implemented on the computer system 500. The user interfaces application and/or any instructions for performing any of the embodiments discussed herein may be encoded on computer-readable media. Computer-readable media includes any media capable of storing data. In some embodiments, the user interface application is client-server-based. Data for use by a thick or thin client implemented on an electronic device computer system 500 is retrieved on-demand by issuing requests to a server remote to the computer system 500. For example, computer system 500 may receive inputs from the user via an input interface and transmit those inputs to the remote server for processing and generating the corresponding outputs. The generated output is then transmitted to the computer system 500 for presentation to the user.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A method for enhancing learning efficiency in digital or physical learning environments, the method being implemented using a Learning Object Sequencer (LO-SEQ) system, comprising:
scheduling a learning object (LO) to be presented to a learner in at least one of a plurality of modalities;
presenting a very short priming object (vs-PO) as a priming stimulus, the vs-PO being semantically or conceptually related to the scheduled LO to be subsequently presented; and
subsequently presenting the scheduled LO after a predefined time period of presenting the vs-PO.

2. The method of claim 1, wherein the plurality of modalities includes visual, auditory, and kinesthetic stimuli.

3. The method of claim 1, further comprising selecting a vs-PO from a vs-PO repository having a plurality of vs-POs.

4. The method of claim 3, wherein the selecting includes correlating the plurality of vs-PO with the scheduled LO and selecting a vs-PO that corresponds to the scheduled LO.

5. The method of claim 4, wherein the vs-PO is correlated with the scheduled LO based on the metadata matching, semantic similarity analysis, concept mapping and ontologies, modality matching, and cognitive load and engagement metrics.

6. The method of claim 5, wherein the metadata comprising a plurality of learning data including subject matter, difficulty level, and learning goals of the LO.

7. The method of claim 1, wherein the modality of vs-PO presented as the priming stimulus correspond to the modality of the scheduled LO.

8. The method of claim 3, wherein the vs-PO is further dynamically selected based on learner specific data including one or more of cognitive load, prior knowledge, and engagement metrics.

9. A system comprising a processor and memory, wherein the processor and memory in combination are operable to implement a method comprising:
scheduling a learning object (LO) to be presented to a learner in at least one of a plurality of modalities;
presenting a very short priming object (vs-PO) as a priming stimulus, the vs-PO being semantically or conceptually related to the scheduled LO to be subsequently presented; and
subsequently presenting the scheduled LO after a predefined time period of presenting the vs-PO.

10. The system of claim 9, wherein the plurality of modalities includes visual, auditory, and kinesthetic stimuli.

11. The system of claim 9, further comprising selecting a vs-PO from a vs-PO repository having a plurality of vs-POs.

12. The system of claim 11, wherein the selecting includes correlating the plurality of vs-PO with the scheduled LO and selecting a vs-PO that corresponds to the scheduled LO.

13. The system of claim 12, wherein the vs-PO is correlated with the scheduled LO based on the metadata matching, semantic similarity analysis, concept mapping and ontologies, modality matching, and cognitive load and engagement metrics.

14. The system of claim 13, wherein the metadata comprising a plurality of learning data including subject matter, difficulty level, and learning goals of the LO.

15. The system of claim 9, wherein the modality of vs-PO presented as the priming stimulus correspond to the modality of the scheduled LO.

16. The system of claim 11, wherein the vs-PO is further dynamically selected based on learner specific data including one or more of cognitive load, prior knowledge, and engagement metrics.
